(19) United States
(12) Patent Application Publication
(10) Pub. No.: US 2011/0310693 A1
(43) Pub. Date: Dec. 22, 2011

(54) FOOD PREPARATION ASSEMBLY

(76) Inventor: Scott D. Maurer, Rocky River, OH (US)

(21) Appl. No.: 12/818,525

(22) Filed: Jun. 18, 2010

(51) Int. Cl. A47J 43/28; B65D 41/16; A23P 1/00; B65D 25/20

(52) U.S. Cl. 366/130; 220/737; 220/780

(57) ABSTRACT

A food preparation assembly includes a container and a cradle that engages the container. The container includes a bowl and a removal lid engaging the bowl. The bowl has a base wall and a side wall defining an opening. The base defines a generally planar base surface that rests on an associated support surface when the bowl is in an upright orientation. The side wall is radially spaced from central axis and the central axis is generally vertically oriented when the bowl is in the upright orientation. The lid covers the opening. The cradle engages the container in a first orientation when the bowl is in the upright orientation. The cradle engages the container in a second orientation when the bowl is in a horizontal orientation. The cradle is positioned substantially similarly with respect to the container when in the first orientation and the second orientation. When the cradle is in the first orientation engaging the bowl in the upright position, a lowermost location on the cradle is offset above or substantially co-planar with the associated surface upon which the bowl rests. When the cradle is in the second orientation and the bowl is in the horizontal orientation, the central axis is generally horizontally oriented and the container is rotatable about the central axis with respect to the cradle. A method for mixing food ingredients is also disclosed.

### BACKGROUND

Mixing ingredients of a salad and other foods typically involves placing the ingredients in a bowl and using utensils to move the ingredients within the bowl. For example, when one desires to toss a salad, the ingredients of the salad are placed into the bowl and salad mixing tongs are used to toss the salad. Where one desires to coat the salad in some dressing, quite a bit of dressing can be needed to coat the salad, since much of the dressing can fall to the bottom of the bowl without adhering to one of the other ingredients in the salad. Moreover, a mess can be made because the ingredients of the salad can easily be scooped out of the bowl while mixing with tongs.

To overcome the disadvantages associated with mixing ingredients with utensils, food tumblers were introduced. These devices are typically motorized and include a barrel that rotates about a horizontal axis to tumble food within the barrel. Such devices are known to marinate food, mix salads and coat meat and fish with breading or other similar substances. These known food tumblers employ large base units that support the barrel during rotation. These large base units require more storage in a kitchen where storage space can be at a premium. Moreover, the barrels in which the ingredients are mixed are typically not attractive enough to be placed directly on one's serving table. Accordingly, the ingredients must be transferred from the barrel of the tumbler to another bowl, which dirties two dishes that will require later cleaning.

### SUMMARY

An example of a food preparation assembly that can overcome at least some of the aforementioned shortcomings includes a container and a cradle that engages the container. The container includes a bowl and a removable lid engaging the bowl. The bowl has a base wall and a side wall defining an opening. The base defines a generally planar base surface that rests on an associated support surface when the bowl is in an upright orientation. The side wall is radially spaced from central axis and the central axis is generally vertically oriented when the bowl is in the upright orientation. The removable lid covers the opening. The cradle engages the container in a first orientation when the bowl is in the upright orientation. The cradle engages the container in a second orientation when the bowl is in a horizontal orientation. The cradle is positioned substantially similarly with respect to the container when in the first orientation and the second orientation. When the cradle is in the first orientation engaging the bowl in the upright position, a lowermost location on the cradle is offset above or substantially co-planar with the associated surface upon which the bowl rests. When the cradle is in the second orientation and the bowl is in the horizontal orientation, the central axis is generally horizontally oriented and the container is rotatable about the central axis with respect to the cradle.

Another example of a food preparation assembly that can overcome at least some of the aforementioned shortcomings includes a bowl, a lid, and a cradle. The bowl includes a base and a side wall having a distal edge with respect to the base. The base rests on an associated support surface when the bowl is in an upright orientation. The side wall is radially spaced from a central axis that is generally vertically oriented when the bowl is in the upright orientation. The lid engages the distal edge of the bowl to cover the bowl. The cradle engages with the bowl to support the bowl in a generally horizontal orientation. The cradle fits into the bowl so as not to extend above the distal edge of the bowl when the bowl is in an upright position. Such a configuration can reduce the storage space required for the food preparation assembly.

Another example of a food preparation assembly that can overcome at least some of the aforementioned shortcomings includes a bowl, a lid, and a cradle. The bowl can be similar to the bowl described in the previous paragraph and include a base and a side wall having a distal edge with respect to the base. The lid is configured to engage the distal edge of the bowl to cover the bowl. The lid includes a peripheral lip having an upwardly extending ridge. The cradle engages with the bowl and the lid in a first orientation when the bowl is in the upright orientation. The cradle engages with the bowl and lid in a second orientation when the bowl is in a horizontal orientation. The cradle includes a channel member configured to receive the lip such that the cradle hangs from the lid when in the first orientation. The cradle can hang from the lid without requiring support of the cradle by an operator of the food preparation assembly. Such an orientation can facilitate engagement of the bowl and lid with the cradle.

A method for mixing food ingredients can include the following steps. The method can include place ingredients into a bowl, covering the bowl with a lid, engaging at least of the bowl and the lid with a cradle, turning the bowl to a horizontal orientation, and rotating the bowl about a generally horizontal axis. More particularly, the method can include, with the bowl in the upright orientation and the lid covering the bowl, engaging at least one of the bowl and the lid with a cradle with a lowermost portion of the cradle being offset from or substantially co-planar with a support surface upon which the bowl rests. The method can also include, with the cradle engaging at least one of the bowl and the lid, turning the bowl to a horizontal orientation such that the cradle rests on the support surface. The method can further include rotating the bowl about a generally horizontal axis with the cradle engaging the lid and the bowl turned to the horizontal orientation.

### BRIEF DESCRIPTION OF THE DRAWINGS

FIG. 1 depicts a side view of a food preparation assembly including a container and a cradle engaging the container. The container includes a bowl and a removable lid.

FIG. 2 is a close-up side view of portions of the lid, the bowl and the cradle with the cradle engaging the bowl when the bowl is in the upright orientation.

FIG. 3 is a side view of the food preparation assembly depicted in FIG. 1 with the bowl in an upright orientation and the cradle engaging the bowl in a first orientation.

FIG. 4 is a side view of the food preparation assembly of FIG. 1 with the bowl in a horizontal orientation and the cradle in a second orientation.

FIG. 5 is a front view of the food preparation assembly shown in FIGS. 3 and 4.

FIG. 6 is a close-up side view of portions of the bowl, the lid and the cradle with the cradle engaging the lid with the bowl in the horizontal orientation.

FIG. 7 is a side view of the cradle shown in FIG. 1 and a container that is smaller (has a smaller volume) than the container depicted in FIG. 1 nested inside the container depicted in FIG. 1.

FIG. 8 is a side view of another food preparation assembly similar to the view shown in FIG. 3.

FIG. 9 is a side view of another alternative embodiment of a food preparation assembly similar to the view shown in FIG. 3.

### DETAILED DESCRIPTION

The description and drawings herein are merely illustrative. Various modifications and changes can be in the structures disclosed without departing from the scope of the appended claims. Various identified components of a food preparation assembly disclosed herein are merely terms that may vary from one manufacturer to another and should not be deemed to limit the present disclosure. The present disclosure is particularly applicable for mixing and coating food ingredients. Nevertheless, the assembly described herein has broader applications and may be used with mixing and coating other items.

Referring now to the drawings, wherein like numerals refer to like parts throughout the several views, FIG. 1 illustrates an example of a food preparation assembly 10 including a container 12 and a cradle 14. The food preparation assembly 10 depicted in FIG. 1 is useful in mixing food ingredients and does not require tongs or other utensils to mix or coat the ingredients. The sleek design of the food preparation assembly 10 also minimizes storage space required to store the food preparation assembly.

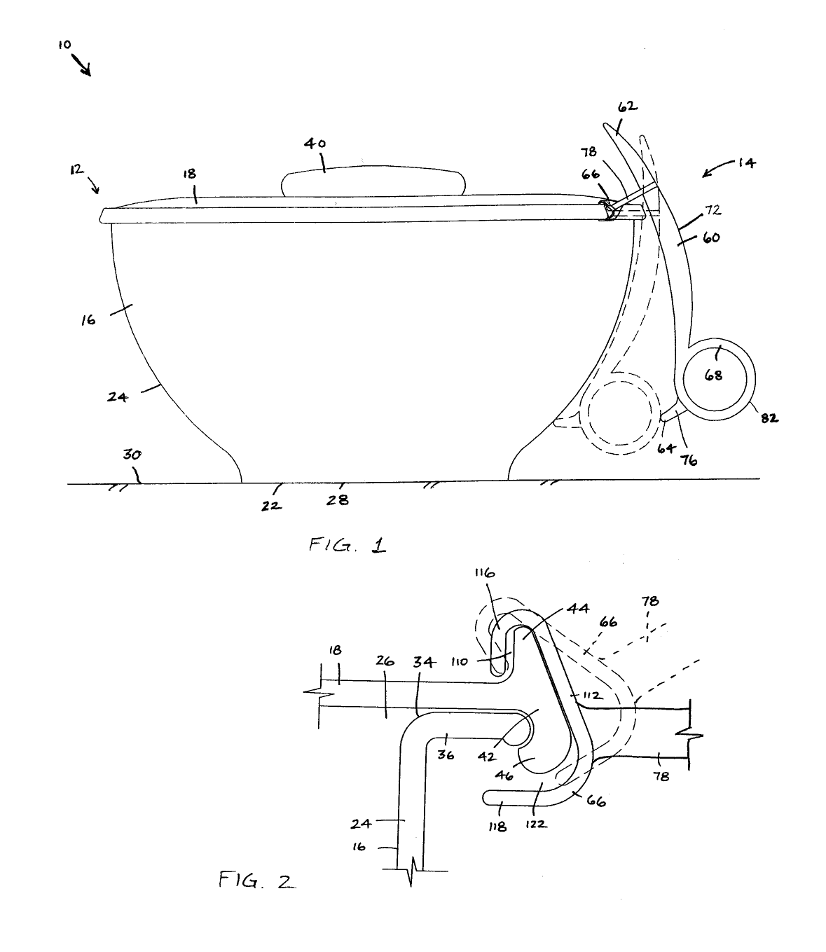

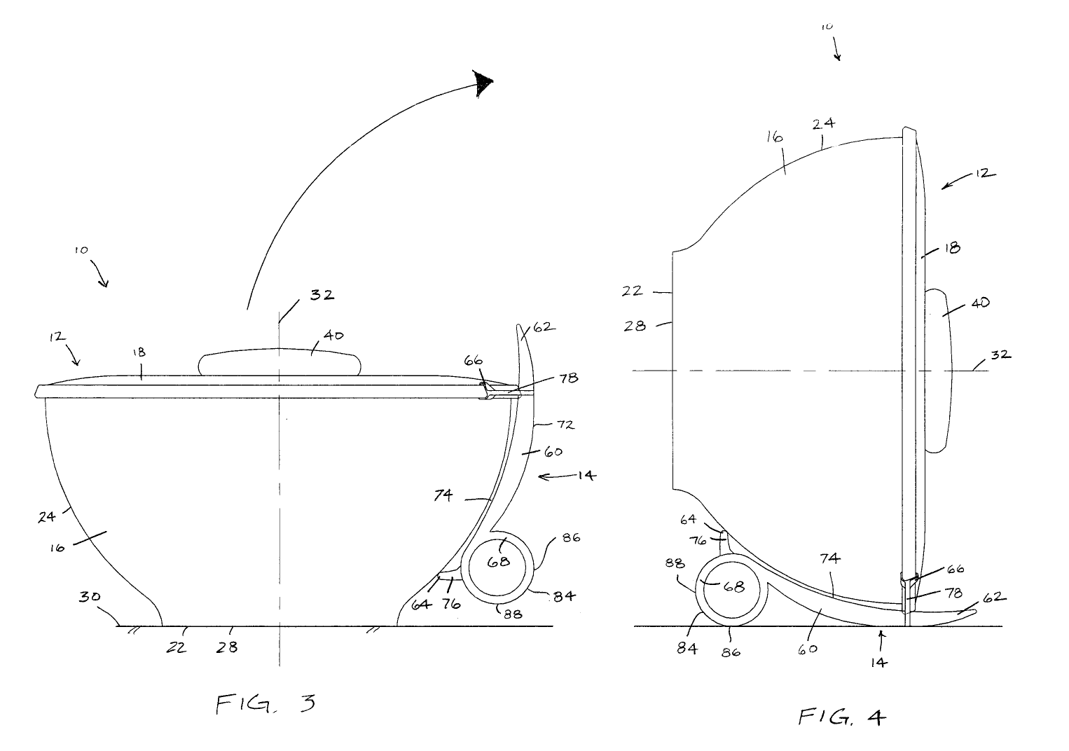

The container 12 depicted in FIG. 1 includes a bowl 16 and removable lid 18. The bowl includes a base 22 and side wall 24 defining an opening 26 (FIG. 2). The base 22 defines a generally planar base surface 28 that rests on a support surface 30, e.g. a table or a countertop, when the bowl is in an upright orientation, such as the orientation shown in FIG. 1. The side wall 24 extends from the base 22 toward the lid 18 and is radially spaced from a central axis 32 (FIG. 3) of the bowl. As seen in FIG. 3, the central axis 32 is generally vertically oriented with respect to the horizontal support surface 30 when the bowl 16 is in the upright orientation. The side wall 24 defines a surface of revolution about the central axis 32 in the depicted embodiment. The side wall 24 includes a distal edge 34 (FIG. 2) with respect to the base 22. The distal edge 34 defines the opening 26 of the bowl 16 and the opening of the bowl is generally circular in the depicted embodiment. With reference to FIG. 2, the bowl 16 also includes an annular flange 36 that extends outwardly from the distal edge 34 for engagement with the lid 18.

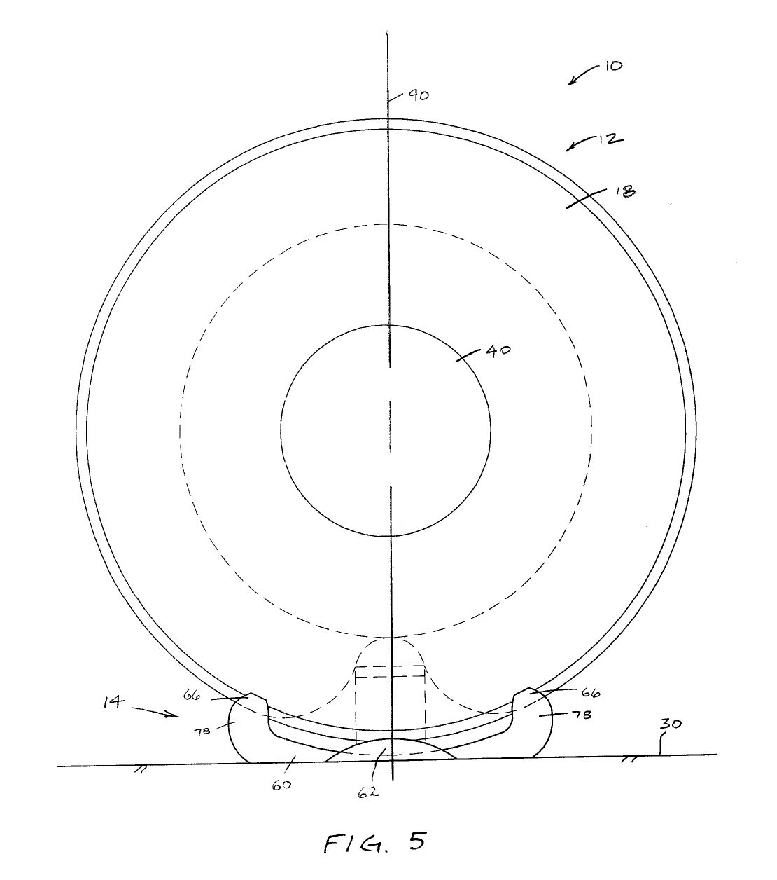

With reference back to FIG. 1 and as described above, the container 12 includes the bowl 16 and the lid 18. The lid 18 is removable from the bowl 16 and engages the bowl for covering the opening 26. The lid 18 retains ingredients within the bowl 16 during tumbling when the bowl 16 is in the horizontal orientation (FIG. 4) and rotating about the central axis 32, which will be described in more detail below. A handle 40 connects to the lid 18 and is generally aligned with the central axis 32 of the bowl 16. With reference to FIG. 4, an operator of the food preparation assembly 10 can grip the handle 40 to rotate the bowl about the central axis 32 to tumble the ingredients within the container 12.

As more clearly seen in FIG. 2, the lid 18 includes a peripheral lip 42 that engages the flange 36 on the side wall 24 of the bowl 16. This attaches the lid 18 to the bowl 16 to cover the opening 26. In the illustrated embodiment, the lip 42 includes an upwardly extending annular ridge 44 and a downwardly depending annular apron 46. The ridge 44 extends upwardly from a more central portion (with respect to the central axis 32) of the lid 18 and the apron 46 depends downwardly from the more central portion of the lid. The apron 46 engages the flange 36 of the side wall 24 of the bowl 16 to attach the lid to the bowl.

With reference back to FIG. 1, the food preparation assembly 10 also includes the cradle 14 that engages the container 12. With reference to FIGS. 3 and 4, the cradle 14 engages the container 12 in a first orientation (shown in FIG. 3) when the bowl 16 is in the upright orientation. With reference to FIG. 4, the cradle 14 engages the container 12 in a second orientation when the bowl 16 is in the horizontal orientation. As seen when comparing FIG. 3 to FIG. 4, the cradle 14 is positioned substantially similarly with respect to the container 12 when in the first orientation (shown in FIG. 3) and in the second orientation (shown in FIG. 4). As seen in FIG. 4, the bowl 16 can be supported by the cradle 14 in a horizontal orientation where the central axis 32 is horizontally oriented and generally parallel to the support surface 30.

With reference back to FIG. 1, the cradle 14 includes a base 60, a handle 62, a first engagement member 64, a second engagement member 66, and a tilting support 68. The cradle 14 can be made from an integrally formed piece of plastic such that the base 60, the handle 62, the first engaging member 64, the second engaging member 66 and the tilting support 68 are all integrally connected with one another. As seen in FIG. 7, the cradle 14 is small enough so that the cradle fits into the bowl 16 so as not to extend above the distal edge 34 (not visible in FIG. 7, the distal edge of the bowl is covered by the lid 18) of the bowl when the bowl is in the upright position (such as that shown in FIG. 1). Such a configuration facilitates storage and shipping of the food preparation assembly 10.

With reference back to FIG. 1, the base 60 of the cradle 14 in the illustrated embodiment is curved to follow the contour of the side wall 24 of the bowl 16. In an alternative arrangement, the base 60 need not follow the contour of the side wall 24 of the bowl 16; however, such a configuration can facilitate aligning the cradle 14 with the container 12 to engage the cradle 14 with the container. An outer surface 72 (with respect to the container 12) of the cradle 14 can include a non-slip material to inhibit movement of the cradle 14 along the support surface 30 during rotation of the container (see FIG. 4). As seen in FIGS. 3 and 4, with the cradle 14 engaging the container 12 an inner surface 74 of the base 60 is typically offset from the side wall 24 of the bowl 16 to minimize friction between the side wall 24 and the cradle 14 during rotation of the container 12 with respect to the cradle.

With reference back to FIG. 1, the cradle 14 also includes a first engagement member support 76 that extends away from the base 60 and supports the first engagement member 64. The cradle 14 also includes a second engagement member support 78 that is axially spaced (with respect to the central axis 32) from the first engagement member support 76. The second engagement member support 78 supports the second engagement member 66. Further description of the engagements members will be provided below.

In the embodiment illustrated in FIG. 1, the handle 62 is an extension of the base 60 and extends from the base beyond the second engagement member support 78. The handle 62 provides a surface for an operator of the food preparation assembly 10 to press down on the cradle 14 to press the cradle against the support surface 30 when rotating the container 12 (see FIG. 4). The external surface 72 of the base 68 can extend over the handle 62 and a non-slip material can be provided on the external surface near the handle to prevent the cradle 14 from slipping while rotating the container about the central axis 32. Accordingly, the handle 62 can contact the support surface 30 when the cradle 14 is in the second orientation, such as that shown in FIG. 4.

With reference back to FIG. 1, the tilting support 68 extends away from the external surface 72 of the base 60 and away from the bowl 16 when the cradle 14 engages the bowl. The tilting support 68 in the illustrated embodiment includes a curved surface 82 that facilitates turning the bowl from the upright orientation (shown in FIG. 3) to the horizontal orientation (shown in FIG. 4). With reference to FIG. 3, an outermost point 86 (with respect to the central axis 32) on the curved surface 82 and the most external portion of the external surface 72 with respect to the central axis 32 contact the support surface 30 when the bowl is in the horizontal orientation and the cradle 14 is in the second orientation. With reference to FIG. 3, when the cradle is in the first orientation engaging the container 12 with the bowl 16 in the upright position, a lowermost location 88 on the cradle 14 is offset above the support surface 30 upon which the bowl 16 rests. Alternatively, the lowermost location 88 could be substantially co-planar with the support surface 30 upon which the bowl rests. Such a design reduces the amount of material that is used to manufacture the cradle 14 and also reduces the amount of space required to store the food preparation assembly 10. The curved surface 84 of the tilting support 68 can also include the non-slip material similar to the external surface 72 of the base 60.

As discussed above, the first engagement member 64 is supported by the first engagement member support 76, which extends from the base 60 or the tilting support 68 of the cradle 14. Similarly, the second engagement member 66 is supported by the second engagement member support 78, which extends from the base 60 toward the container 12. As seen in FIG. 5, two second engagement member supports 78 can be located on opposite sides of an axis 90 that is coincident with a diameter of the bowl 16 and perpendicular to the support surface 30. Accordingly, two second engagement members 66 can engage the container 12 at two angularly spaced locations near a periphery of the container. With reference back to FIG. 4, with the cradle 14 in the second orientation and the bowl 16 in the horizontal orientation ready to tumble ingredients, the first engaging member 64 contacts the container 12 at a first location on an outer surface of the bowl axially spaced from the base surface 28 in a direction toward the lid 18. Also, the second engaging member 66 is axially spaced from the first engaging member 64 and contacts the container 12 at a second location on an outer surface of the bowl 16 or the lid 18. As shown in FIG. 3, the second engaging member 66 engages an outer surface of the lid.

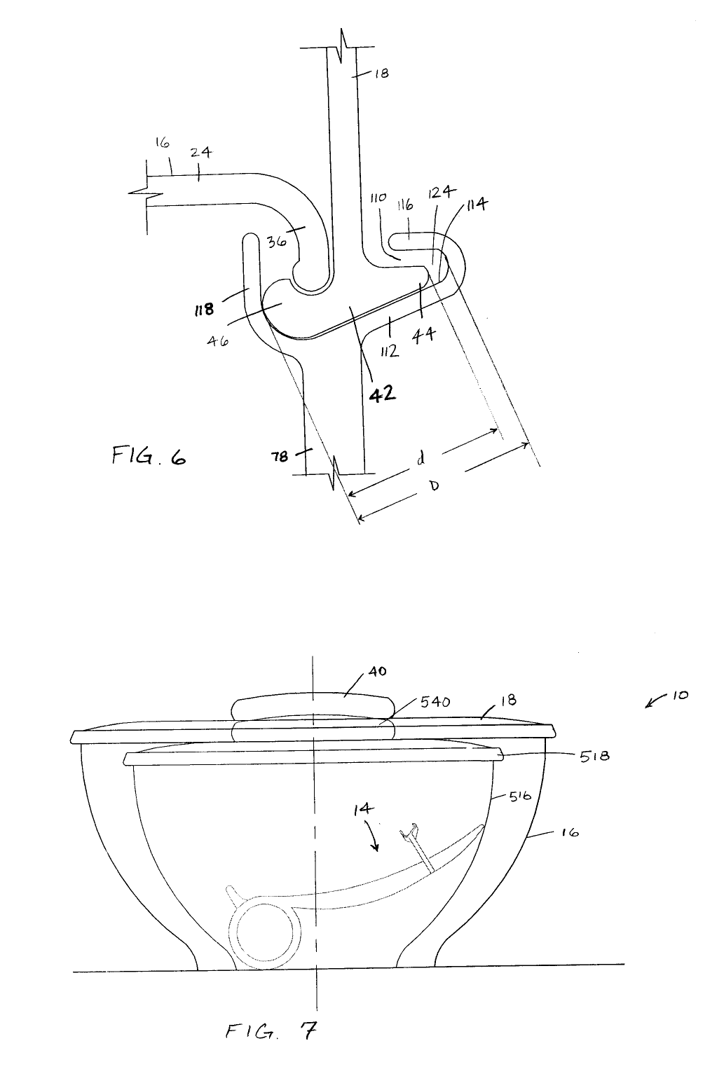

The engaging members 64 and 68 can take many configurations, a few of which will be described in more detail below. With reference to FIG. 6, the second engaging member 66 can be a channel member for receiving the lip 42 of the lid 18. The cradle 14 can include the channel member and the channel member is configured to receive the lip 42 such that the cradle 14 hangs from the lid 18 when in the first orientation, such as that shown in FIG. 3, without requiring support of the cradle by an operator of the food preparation assembly 10. With continued reference to FIG. 6, the lip 42 of the lid 18 has a dimension d measured between a distal-most location on the ridge 44 with respect to the lid 18 and a farthest-most location on the apron 46 with respect to the lid. The channel member 66 defines a channel 110 that receives the lip 42. The channel 110 has a maximum dimension D measured parallel with the dimension d, and D is greater than d. The channel member 66 in the illustrated embodiment includes a channel base 112 defining a channel base surface 114, a first appendage 116 extending from a first end of the channel base and generally towards the bowl 16 and a second appendage 118 extending from a second end of the channel base 112 and generally towards the bowl. The channel base surface 114, the first appendage 116 and the second appendage 118 define the channel 110. As seen in FIG. 2, the channel base surface 114 is offset from vertical when the cradle 14 is in the first orientation. As seen in FIG. 6, the channel base surface 114 is offset from horizontal when the cradle 14 is in the second orientation.

With reference back to FIG. 2, when the cradle 14 hangs from the lid 18 when in the first orientation, a gap 122 is provided between the apron 46 and the appendage 118. With reference to FIG. 6, the channel base surface 114 is sloped downwardly and towards the base 22 of the bowl 16 (FIG. 2) when the cradle 14 is in the second orientation such that a gap 124 is provided between the lip 42, and more particularly the ridge 44, and the first appendage 116 when the cradle is in the second orientation. Because of the downward slope of the channel base surface 114, the gap 122 that was provided when the cradle was in the first orientation closes and the gap 124 is provided when in the second orientation, which is shown in FIG. 6. While the bowl rotates about the central axis 32 (see FIG. 3), the second appendage 118 limits axially movement of the bowl and the downward slope of the channel base surface 114 encourages downward movement of the container 12. The generally C-shape of the first appendage 116 also inhibits vertical movement of the container 12 because any vertical movement of the container would result in the annular ridge 44 contacting the first appendage 116. Accordingly, axial movement of the bowl 16 (along the central axis 32) with respect to the cradle 14 is inhibited by the configuration of the channel member and the peripheral lip 42. With reference back to FIG. 4, the first engagement member 64, therefore, need only support vertical loads imposed by the bowl 16 and need not restrain any axial movement of the bowl.

The food preparation assembly can take alternative configurations. The configurations are similar to the embodiment discussed with reference to FIGS. 1-7; therefore, the differences between the alternative embodiments and the embodiment described with reference to FIGS. 1-6 will be highlighted with the understanding that the remaining components and portions thereof that are not discussed in detail are similar to the components and portions thereof described above.

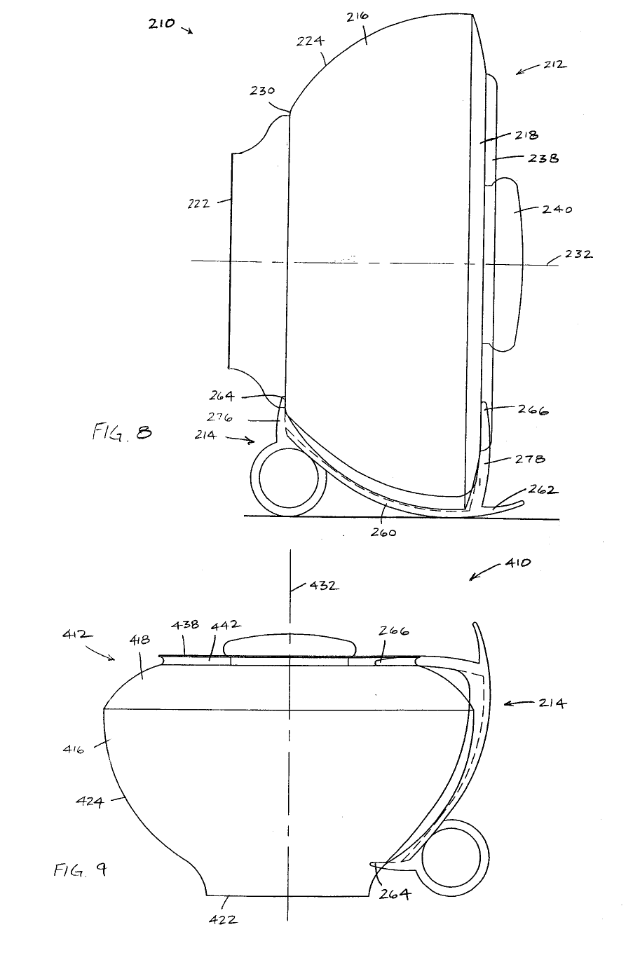

With reference to FIG. 8, a food preparation assembly 210 includes a container 212 and a cradle 214. The container 212 includes a bowl 216 and a lid 218. The bowl 216 includes a base 222 and a side wall 224. A ledge 230 is formed in the side wall 224 to provide an annular surface that is generally normal to a central axis 232 of the bowl 216. The lid 218 is removable from the bowl 216. The lid 218 includes a generally cylindrical projection 238 that extends away from the base 222 of the bowl 216. A handle 240 connects to the lid 218. A central axis of the generally cylindrical portion 238 is coaxial with the central axis 232 of the bowl.

The cradle 214 includes a base 260, a handle 262, a first engaging member 264, a second engaging member 266, and a tilting support 268. The first engaging member 264 is supported by a first engaging member support 276 and a second engaging member 266 is supported by a second engaging support 278. The first engaging support 264 cooperates with the ledge 230 formed on the bowl 216. The second engaging member 266 cooperates with the cylindrical projection 238 formed on the lid 218. As seen in FIG. 8, the container 212 is trapped between the first engaging member 264 and the second engaging member 266 so that axial movement of the container 212, with respect to the central axis 232, is inhibited. The ledge 230 can define a first annular surface with respect to the central axis 232 and the cylindrical projection 238 can define a second annular surface with respect to the central axis. In the embodiment depicted in FIG. 8, the engagement members are simply curved surfaces that engage an outer surface of the container, either the bowl 216 or the lid 218. Alternatively, the engaging members 264 and 266 could include rollers that each attach to a respective engaging member support 276, 278, as well as cylindrical posts that provide a small surface area upon which the container can ride when the bowl 216 is in the horizontal orientation.

FIG. 9 depicts another embodiment of a food preparation assembly 410. The food preparation assembly includes a container 412 and a cradle 214, which is the same as the cradle depicted in FIG. 8. The container 412 includes a bowl 416 and a lid 418. The bowl includes a base 422 and a side wall 424. The side wall is curved with respect to a central axis 432 of the bowl such that the first engaging member 264 contacts the bowl adjacent a point of inflection on a curve of the outer surface of the side wall 424 taken in a cross-section through the central axis 432. The lid 418 includes a generally cylindrical protrusion 438 that defines a channel 442 in which is received the second retaining member 266. The channel 442 defines two annular surfaces against which the first engaging member 266 can contact to inhibit axial movement of the bowl 412 with respect to the cradle 214.

FIG. 7 depicts the food preparation assembly 10 including two containers and a cradle. The first container 12 includes the (larger) bowl 16 and the (larger) lid 18. The second container 510 includes a smaller bowl 516 and a smaller lid 518. The smaller bowl 516 and the cradle 14 both nest into the larger bowl 16 with neither the smaller bowl nor the cradle extending above the distal edge of the larger bowl when the larger bowl is in the upright position. Moreover, each lid 18 and 518 includes a respective handle 40, 540, respectively. When shipping the food preparation assembly 510, the lids can be inserted upside down so that each handle 540, 542 extends down into the bowl from the distal edge 530 to minimize packaging of the bowl. Nevertheless, with the handle disposed within the confines of the side wall of the larger bowl 516, the cradle 514 still can nest within the bowl. Moreover, the cradle 14 is configured to cooperate with each of the larger bowl 16 and the smaller bowl 516. For example, when comparing FIGS. 7 and 9, the bowl 416 in FIG. 9 is about the same size as the smaller bowl 516 in FIG. 7; however, the same cradle can be used with each bowl shown in FIG. 7. Accordingly, if one desired a smaller serving of salad, for example, he could choose to use a smaller bowl. If more salad is desired, then the cradle can be used with the larger bowl.

A method for mixing ingredients will be described with reference to the embodiment depicted in FIGS. 1-6, but could be used with other food preparation assemblies. The method includes placing ingredients into a bowl 16 in an upright orientation. The method further includes covering the bowl 16 with a lid 18. With the bowl 16 in the upright orientation and the lid 18 covering the bowl, the method further includes engaging at least one of the bowl and the lid with a cradle 14 with a lowermost portion 88 of the cradle being offset from or substantially co-planar with a support surface 30 upon which the bowl rests. With the cradle 14 engaging at least one of the bowl 16 and the lid 18, the method could further include turning the bowl to a horizontal orientation such that the cradle rests on the support surface. With the cradle 14 engaging the lid 18 and the bowl 16 turned to the horizontal orientation, the method can further include rotating the bowl about a generally horizontal axis 32. For the method described above, engaging at least one of the bowl 16 and the lid 18 can include engaging the bowl with a first engaging member 76 of the cradle 14 and engaging the lid with a second engaging member 66 of the cradle. Additionally, for the method described above, engaging at least one of the bowl and the lid can also include receiving a peripheral lip 42 of the lid 18 with a channel member 66 of the cradle 14 such that the cradle hangs from the lid, such as shown in FIG. 3.

A food preparation assembly has been described above with reference several embodiments. Modifications and alterations will occur to those upon reading and understanding the preceding detailed description. The food preparation assembly defined in the appended claims should not be limited to only the embodiments described above. Instead, the food preparation assembly defined by the appended claims should also include all equivalent structures that fall within the scope of the appended claims.

It will be appreciated that various of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A food preparation assembly, comprising:
a container including
a bowl having a base and side wall defining an opening, the base defining a generally planar base surface that rests on an associated support surface when the bowl is in an upright orientation, the side wall being radially spaced from a central axis and the central axis being generally vertically oriented when the bowl is in the upright orientation, and
a removable lid engaging the bowl for covering the opening; and
a cradle that engages the container in a first orientation when the bowl is in the upright orientation and that engages the container in a second orientation when the bowl is in a horizontal orientation,
wherein the cradle is positioned substantially similarly with respect to the container when in the first orientation and the second orientation,
when the cradle is in the first orientation engaging the container with the bowl in the upright position a lowermost location on the cradle is offset above or substantially coplanar with the associated surface upon which the bowl rests,
when the cradle is in the second orientation and the bowl is in the horizontal orientation the central axis is generally horizontally oriented and the container is rotatable about the central axis with respect to the cradle.

2. The assembly of claim 1, wherein the lid includes a peripheral lip having an upwardly extending ridge and a downwardly depending apron, wherein the apron engages the bowl to fasten the lid to the bowl, wherein the cradle includes a channel member configured to receive the lip such that the cradle hangs from the lid when in the first orientation without: requiring support of the cradle by an operator of the food preparation assembly.

3. The assembly of claim 2, wherein the lip has a dimension d measured between a distal-most location on the ridge with respect to the lid and a farthest-most location on the apron with respect to the lid, wherein the channel member defines a channel that receives the lip, wherein the channel has a maximum dimension D measured parallel with the dimension d, wherein D is greater than d.

4. The assembly of claim 3, wherein the channel member includes a channel base defining a channel base surface, a first appendage extending from a first end of the channel base, and a second appendage extending from a second end of the channel base and generally towards the bowl, wherein the channel base surface, the first appendage and the second appendage define the channel, wherein the channel base surface is offset from vertical when the cradle is in the first orientation, wherein the channel base surface is offset from horizontal when the cradle is in the second orientation.

5. The assembly of claim 4, wherein the channel base surface is sloped downwardly and towards the base of the bowl when the cradle is in the second orientation such that a gap is provided between the lip and the first appendage when the cradle is in the second orientation.

6. The assembly of claim 1, wherein the cradle includes a first engaging member contacting the container at a first location on an outer surface of the bowl axially spaced from the base surface in a direction toward the lid and a second engaging member axially spaced from the first engaging member and contacting the container at a second location on an outer surface of the bowl or the lid.

7. The assembly of claim 6, wherein the lid includes a base and a peripheral lip, wherein the second engaging member is a channel member for receiving the lip.

8. The assembly of claim 6, wherein the first location is on the bowl and the second location is on the lid.

9. The assembly of claim 1, wherein the side wall terminates at a distal edge with respect to the base and the cradle fits into the bowl so as to not extend above the distal edge of the bowl when the bowl is in the upright position.

10. The assembly of claim 1, wherein the cradle includes a handle that contacts the associated support surface when the cradle is in the second orientation.

11. A food preparation assembly, comprising:
a bowl including a base and side wall having a distal edge with respect to the base, wherein the base rests on an associated support surface when the bowl is in an upright orientation, the side wall being radially spaced from a central axis that is generally vertically oriented when the bowl is in the upright orientation;
a lid engaging the distal edge of the bowl to cover the bowl; and
a cradle engageable with the bowl to support the bowl in a generally horizontal orientation, wherein the cradle fits into the bowl so as to not extend above the distal edge of the bowl when the bowl is in an upright position.

12. The assembly of claim 11, wherein the bowl includes a larger bowl and a smaller bowl, wherein the smaller bowl and the cradle both nest into the larger bowl with neither the smaller bowl nor the cradle extending above the distal edge of the larger bowl when the larger bowl is in the upright position.

13. The assembly of claim 12, wherein the cradle engages each bowl in a first orientation when the respective bowl is in the upright orientation and the cradle engages each bowl in a second orientation when the respective bowl is in the generally horizontal orientation, wherein the cradle is positioned substantially similarly with respect to each bowl when in the first orientation and the second orientation,
when the cradle is in the first orientation engaging a respective bowl in the upright position a lowermost portion on the cradle is offset above or substantially coplanar with the associated surface upon which the respective bowl rests,
when the cradle is in the second orientation engaging a respective bowl in the horizontal orientation the central axis is generally horizontally oriented, axial movement of the respective bowl with respect to the cradle is inhibited and the respective bowl is rotatable about the central axis with respect to the cradle.

14. A food preparation assembly, comprising:
a bowl including a base and side wall having a distal edge with respect to the base, the base rests on an associated support surface when the bowl is in an upright orientation, the side wall being radially spaced from a central axis that is generally vertically oriented when the bowl is in the upright orientation;
a lid configured to engage the distal edge of the bowl to cover the bowl, wherein the lid includes a peripheral lip having an upwardly extending ridge; and
a cradle engageable with the bowl and the lid in a first orientation when the bowl is in the upright orientation and engageable with the bowl and the lid in a second orientation when the bowl is in a horizontal orientation, wherein the cradle includes a channel member configured to receive the lip such that the cradle hangs from the lid when in the first orientation.

15. The assembly of claim 14, wherein the lip has a dimension d measured between an distal-most location on the ridge with respect to the lid and a farthest-most location on the apron with respect to the lid, wherein the channel member defines a channel that receives the lip, wherein the channel has a dimension D measured parallel with the dimension d, wherein D is greater than d.

16. The assembly of claim 15, wherein the channel member includes a channel base surface, wherein the channel base surface is offset from vertical when the cradle is in the first orientation, wherein the channel base surface is offset from horizontal when the cradle is in the second orientation.

17. The assembly of claim 16, wherein the channel base surface is sloped downwardly and towards the base of the bowl when the cradle is in the second orientation such that a gap is provided between the lip and a side surface of the channel.

18. A method for mixing food ingredients comprising:
placing ingredients into a bowl in an upright orientation;
covering the bowl with a lid;
with the bowl in the upright orientation and the lid covering the bowl, engaging at least one of the bowl and the lid with a cradle with a lowermost portion of the cradle being offset from or substantially coplanar with a support surface upon which the bowl rests;
with the cradle engaging at least one of the bowl and the lid, turning the bowl to a horizontal orientation such that the cradle rests on the support surface; and
with the cradle engaging the lid and the bowl turned to the horizontal orientation, rotating the bowl about a generally horizontal axis.

19. The method of claim 18, wherein engaging at least one of the bowl and the lid includes engaging the bowl with a first engaging member of the cradle and engaging the lid with a second engaging member of the cradle.

20. The method of claim 18, wherein engaging at least one of the bowl and the lid includes receiving a peripheral lip of the lid with a channel member of the cradle such that the cradle hangs from the lid.
